(19) United States
(12) Patent Application Publication
(10) Pub. No.: US 2015/0112643 A1
(43) Pub. Date: Apr. 23, 2015

(54) INFRA-RED ANALYSIS OF DIAMONDS

(71) Applicant: DE BEERS CENTENARY AG, Lucerne 6 (CH)

(72) Inventors: Rizwan Khan, London (GB); Nicholas Matthew Davies, Berkshire (GB); David Fisher, Berkshire (GB); James Gordon Charters Smith, Buckinghamshire (GB)

(21) Appl. No.: 14/406,666

(22) PCT Filed: Jun. 12, 2013
(86) PCT No.: PCT/EP2013/062156

§ 371 Date: Dec. 9, 2014

(30) Foreign Application Priority Data
Jun. 15, 2012 (GB) 1210690.2

(51) Int. Cl. G01N 21/3563; G01N 21/87

(52) U.S. Cl. CPC G01N 21/3563; G01N 21/87; G01N 2201/12
USPC 702/189

(57) ABSTRACT

The invention provides a method of automating the classification of a diamond gemstone. An infra-red absorption spectrum of the gemstone is provided. Features corresponding to absorption by water and intrinsic absorption by a diamond lattice are subtracted from the absorption spectrum. The spectrum is analysed to identify predetermined absorption features corresponding to lattice defects in the diamond. The gemstone is classified according to the intensities of the predetermined absorption features. The results of the classification are saved in a database.

### TECHNICAL FIELD

The invention relates to the automation of analysis of diamonds using infra-red absorption spectroscopy.

### BACKGROUND

It is considered crucial that synthetic diamond sold as gemstones should be properly disclosed to avoid confusion and to maintain consumer confidence. As a result of improvements in synthesis methods and because synthetic diamond has the same intrinsic crystal structure as natural diamonds, it is frequently extremely difficult or impossible to determine through a visual examination alone that a stone is synthetic. In addition, it has become apparent in recent years that some natural diamonds can be treated, for example by radiation and/or annealing, to improve their optical properties. It is also important to disclose when such treatments have been applied but they can also be difficult to detect visually.

Instruments are available to assist in identification of natural untreated diamonds, synthetic diamond and treated diamonds. For example DiamondSure®, DiamondView® and DiamondPLus® are manufactured by the Diamond Trading Company and are used by grading laboratories. DiamondSure® operates by measuring the absorption of visible light by a diamond. Those stones having an absorption spectrum indicating potential synthetics or treated diamond are categorised as such. In DiamondView® stones identified by DiamondSure® as requiring further investigation are illuminated with ultraviolet radiation and the user can study images of the resulting surface fluorescence, captured using a camera. Given that the fluorescence colours and patterns from synthetic diamond differ greatly from those of natural diamonds, DiamondView® makes it possible for gemmological laboratories and jewelry professionals to determine whether a diamond is natural or synthetic. Phosphorescence images, captured using DiamondView® can provide additional evidence.

1-2% of diamonds with natural origin, are nominally free of nitrogen impurity. These are called type II diamonds and they form an important category of DiamondSure referrals. After the natural origin has been confirmed using DiamondView it is necessary to check whether such stones have been artificially treated to improve their colour. DiamondPLus can be used to make a rapid photoluminescence measurement that significantly reduces the number of type II diamonds that need further more detailed testing.

Although use of this instrument methodology is effective in preventing synthetics and treated diamond from being identified as untreated natural diamonds, further analysis is required in particular cases, such as type II diamonds that are not passed by DiamondPLus and fancy colour diamonds that have high DiamondSure referral rates, for example yellow or yellow-brown stones. In many cases, such further analysis will include measurement and interpretation of infra-red (IR) absorption spectra to categorise diamonds according to the key infrared active defects that they contain. At present this is usually achieved by measuring the stones manually using a lab-based spectrometer, analysing the data by hand and dispensing the stone accordingly. This is laborious and time-consuming and requires in-depth knowledge of skilled scientists and technicians (which is not readily transferable information).

It would therefore be desirable to provide a system for automating the analysis of infra-red absorption spectra.

### SUMMARY

In accordance with one aspect of the present invention there is provided a method of automating the classification of a diamond gemstone from an infrared absorption sample spectrum of the gemstone. Features corresponding to absorption by water vapour and intrinsic absorption by a diamond lattice are subtracted from the absorption spectrum. The sample spectrum is analysed to identify predetermined absorption features corresponding to lattice defects in the diamond. The gemstone is classified according to the intensities of the predetermined absorption features. The results of the classification are saved in a database. The gemstone may also be dispensed accordingly.

Thus the spectrum is processed to remove unwanted features (measurement artifacts or intrinsic absorption), enabling features of interest to be identified and compared automatically.

In order to automate the analysis of spectra reliably, an early check may test for spectrum saturation, to determine if the signal to noise ratio is likely to be sufficient to obtain meaningful results. This may be achieved by measuring the noise (for example by integrating a Fourier transform of the spectrum) over a predetermined spectral region in which no absorption features are present and giving a ‘high saturation’ result if the noise exceeds a predetermined threshold.

The algorithmic step of subtracting features corresponding to absorption by water may include fitting the sample spectrum over a predetermined spectral range (e.g. 3500-4000 cm⁻¹) to a reference water spectrum including features characteristic of absorption by water, and subtracting the fitted water spectrum from the sample spectrum. Similarly, subtracting features corresponding to intrinsic absorption by the diamond lattice may include fitting the spectrum over a predetermined spectral range to a reference type IIa spectrum including features characteristic of absorption by a type IIa diamond, and subtracting the fitted type IIa spectrum from the sample spectrum. Fitting to the water and/or type IIa spectrum may be carried out using a linear non-negative least squares fit.

Automatically fitting the absorption spectrum to a standard spectrum of absorption by water may also include shifting the reference water spectrum incrementally to a plurality of different wavenumber positions over a predetermined range and fitting the water spectrum to the absorption spectrum at each position, and comparing the fit at each wavenumber position. The shifted spectrum having the best fit may then be that subtracted from the absorption spectrum.

A baseline may be automatically calculated for the formatted spectrum by identifying a plurality of local minima in specified regions of the sample spectrum and fitting a second-order polynomial to the local minima. This baseline may then be subtracted from the sample spectrum. Specified regions may include a region from the lowest wavenumber point recorded in the spectrum to a point up to 50 cm⁻¹ higher (e.g. 400-450 cm⁻¹), 1400-1650 cm⁻¹, 4500-4700 cm⁻¹, and a region from 200-100 cm⁻¹ less than the highest wavenumber point recorded (e.g. 6800-6900 cm⁻¹).

The analysis may include automatically fitting to the formatted spectrum, within a region corresponding to one-phonon absorption, a combination of reference spectra having features characteristic of IR absorption by A, B, D, N_{S}⁰ and N_{S}⁺ centres, and determining intensities of some or all of these centres on the basis of the fitting to the reference spectra. The stone may then be classified on the basis of the determined intensities.

This analysis may include automatically performing a three-component fit to the one-phonon region of the formatted spectrum using reference A, B and D spectra, and a five-component fit to using reference A, B, D, N_{S}⁰ and N_{S}⁺ spectra. The quality of the three-component and five-component fits may then be compared, for example using a X² test, and the stone may be classified on the basis of the quality comparison. For example, if the five-component fit is better than the three-component fit by more than a predetermined threshold, it can be concluded that a significant proportion of single substitutional nitrogen is present in the stone, in which case it is unlikely to be a natural diamond. This fitting may be carried out using linear non-negative least squares fitting.

Local baselines may be automatically calculated for absorption features, the local baseline for each feature being calculated by fitting a second-order polynomial to a plurality of data points at predefined wavenumber increments either side of a peak position of that feature. A suitable function may then be fitted to each absorption feature to identify the intensity of that feature following subtraction of the local baseline from a region surrounding the feature. Fitting suitable functions may include non-linear least-squares fitting. Absorption features which may be analysed using this approach include those with lines at 1450 cm⁻¹, 3123 cm⁻¹, 1344 cm⁻¹ and/or 2802 cm⁻¹, and/or to absorption features corresponding to platelets such as those between 1350 and 1380 cm⁻¹, and particularly between 1358 and 1378 cm⁻¹.

The invention also provides apparatus configured to carry out the methods described above.

The invention also provides an algorithm that sequences the steps described above which, if followed, results in a categorisation being made on the gemstone.

The invention also provides a computer program comprising computer readable code which, when operated by a processor, causes the processor to carry out any of the methods described above. The computer program may be stored on a computer readable medium.

### BRIEF DESCRIPTION OF THE DRAWINGS

Some preferred embodiments of the invention will now be described by way of example only and with reference to the accompanying drawings, in which:

FIG. 1 is a schematic illustration of the intrinsic infra-red absorption spectrum of diamond, together with absorption spectra of diamonds having nitrogen defects;

FIG. 2 is a schematic illustration of an absorption feature caused by the presence of platelets;

FIG. 3 is a flow chart illustrating the steps involved in analysing the IR absorption spectrum of a diamond;

FIG. 4 is a flow chart of the implementation of classification of diamond types based on the IR analysis;

FIG. 5 is a plot of fast Fourier-transformed data of an IR absorption spectrum exhibiting significant saturation in the one-phonon region;

FIG. 6 is a schematic illustration of fitting to reference type IIa and water spectra;

FIG. 7 illustrates an IR absorption spectrum before and after subtraction of a fitted type IIa spectrum and standard water spectrum;

FIG. 8 illustrates an absorption spectrum fitted using A, B, D, N_{S}⁰ and N_{S}⁺ components;

FIG. 9 illustrates an example of non-linear fitting of a platelet feature to a sample spectrum; and

FIG. 10 is a schematic illustration of a system suitable for carrying out automatic analysis of an infra-red absorption spectrum.

### DETAILED DESCRIPTION

Nitrogen is the most common atomic impurity found in natural diamond, and is also common in synthetic diamond unless steps are taken to exclude it deliberately. It resides in the diamond lattice in a variety of structural forms, and creates absorption in the one-phonon region of the IR spectrum. Diamonds containing a measurable proportion of nitrogen are classified as Type I, while those that are nominally nitrogen-free (i.e. below about 10 ppm) are classified as Type II.

Type I diamonds are further subdivided depending on the aggregation state of the nitrogen in the crystal lattice. Diamonds in which the nitrogen is generally incorporated at individual substitutional sites (known as C-centres, or N_{S}⁰) are classified as Type Ib. Most synthetic diamond is of this type. The concentration of nitrogen in C-centres can be determined from the strength of absorption of a peak at 1130 cm⁻¹. Absorption spectra of such diamonds also include a sharp peak at 1344 cm⁻¹ caused by a localised vibrational mode at the C-centre. On geological timescales, this type of defect diffuses through the diamond lattice and aggregates into pairs of substitutional nitrogen atoms, known as A-centres, and diamonds in which the nitrogen is predominantly in this configuration are termed type IaA: it is therefore unusual to find natural type Ib diamonds.

A-centres may aggregate further to form clusters of four adjacent nitrogen atoms arranged around a vacancy, known as B-centres. Diamonds containing only B-centres are classified as type IaB, but the vast majority of natural diamonds contain a mixture of A and B centres and are termed type IaAB.

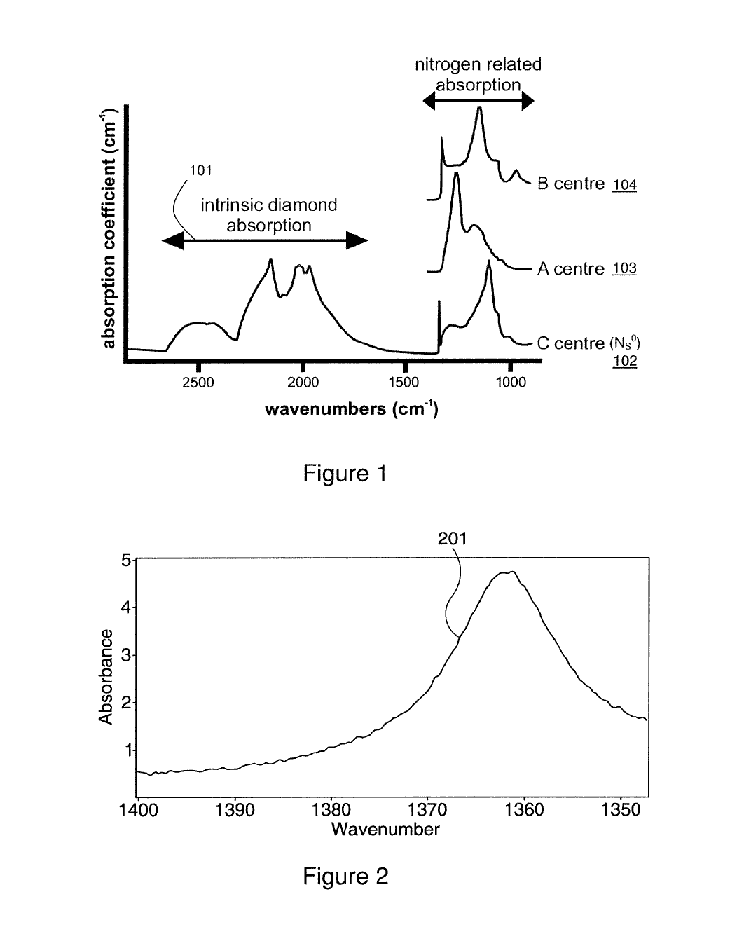

FIG. 1 illustrates the IR absorption spectrum of diamond, showing the intrinsic absorption spectrum 101 of the diamond lattice in the two-phonon region between about 1500 and 2700 cm⁻¹. The slight dip in the feature at around 1992 cm⁻¹ has been shown to have a constant absorption per unit thickness of diamond. FIG. 1 also shows typical absorption spectra 102, 103, 104 in the one-phonon region of diamonds having large concentrations of nitrogen C-centres (N_{S}⁰), A-centres and B-centres as described above.

A by-product of the formation of B centres is the expulsion of carbon atoms to create the required vacancies. These interstitial carbon atoms aggregate to form platelets, which can create two important absorption features within the region of 1400 to 1000 cm⁻¹. The first is the B′ band, whose peak occurs within the region 1358 to 1378 cm⁻¹ and has a tail that can extend into higher wavenumbers. An example of such a feature 201 is shown in FIG. 2. The area under this peak rather than its peak intensity is generally used as a measure of the abundance of platelets in a diamond because the band becomes broader and more asymmetric as the strength of the feature increases. The peak position versus width, or width versus asymmetry, can be used as an indication as to whether the diamond has been subjected to high-temperature treatment.

The second important absorption feature is known as the D component and represents lattice vibrational modes of the platelets and occurs in the range 1340 to 1140 cm⁻¹. As this overlaps the region of 1282 cm⁻¹ where both A and B centres are quantified, it can have an effect on the measurement of nitrogen concentration.

A further component often present in IR spectra with an absorption maximum at 1332 cm⁻¹ is known as the X-component and has been linked with positively charged single-substitutional nitrogen (Nₛ⁺).

Hydrogen is another common impurity in diamond. The two main hydrogen-related peaks in diamond, the dominant 3107 cm⁻¹ and the subsidiary 1405 cm⁻¹, have been recognised as being hydrogen-related. It has been postulated that the most likely sites for the hydrogen to reside in the diamond would be, at internal surfaces, perhaps at the surfaces of submicroscopic cavities, or at inclusion/diamond interfaces. Hydrogen defects are particularly common in synthetic diamond produced by chemical vapour deposition (CVD) techniques, and much CVD diamond exhibits an absorption peak at 3123 cm⁻¹, believed to be a vibration of the nitrogen-vacancy-hydrogen (NVH) defect that is incorporated during growth.

As discussed above, identifying different impurities from absorption spectra and estimating their concentrations is a difficult task, currently carried out by skilled individuals. However, it is possible to extract useful data from IR absorption spectra automatically if such spectra are processed in a structured manner. This then enables the accurate classification of stones into Types IaAB, IaA, IaB, IIa and IIb, and allows the identification of suspicious stones. This has not previously been achieved for a number of reasons:

First, it is important to remove spectral artifacts such as water vapour automatically. This is problematic due to the following issues including but not limited to:
(i) the overlapping of spectral features and artifacts;
(ii) miscalibration of sample and reference spectra;
(iii) the lines in one region of the spectrum may not match those in another region of the spectrum;
(iv) the lines may be shifted in position compared to the reference spectrum; and
(v) that the degree of shift might be different in different regions of the spectrum.

Second, it is useful to perform a ‘rough’ baseline over the whole of the spectrum automatically. This can be problematic, due to the fact that different diamonds possess very different spectra, and intelligent criteria must be applied in order to determine which datapoints are ‘sample spectrum’ and which are ‘baseline’ so that the baseline can be effectively and accurately fitted.

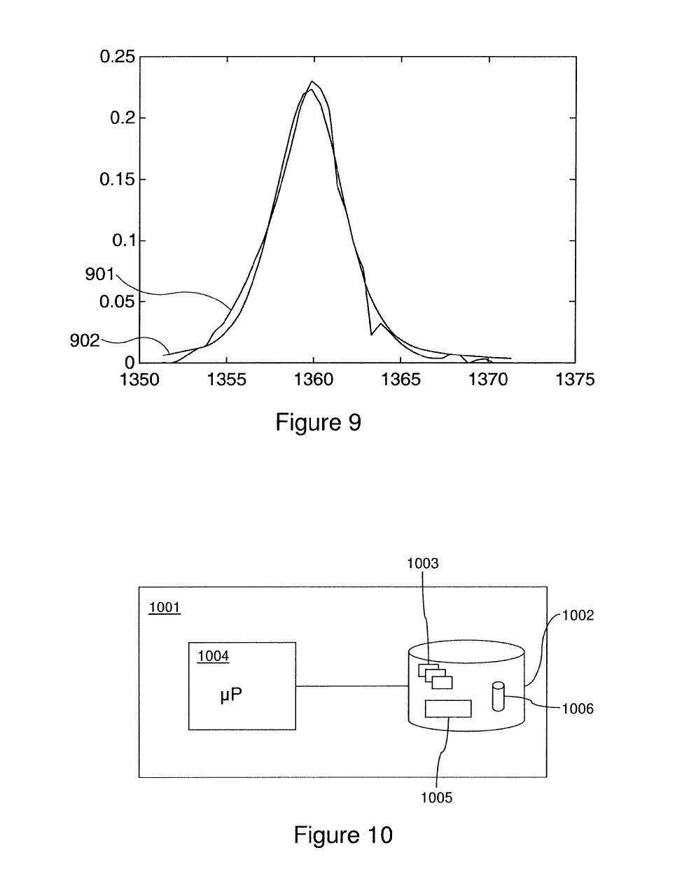

Third, it is important to fit a baseline to individual spectral features to a high degree of accuracy and reliability. This is particularly important for features where the line shape, as well as the position and intensity, is a critical parameter for the decision-making process. An example of such a feature is the platelet (see FIG. 9), where the feature is notoriously difficult to fit a baseline to: (i) the feature is broad (usually greater than 5 cm⁻¹); (ii) the feature is highly asymmetric; (iii) other lines may be in the vicinity; (iv) the feature is immediately adjacent to the nitrogen-related absorption in the single phonon region. A fully automated, failsafe way of fitting the baseline before fitting to the spectral feature is imperative so that reliable parameters may be determined from it.

Fourth, and related to the above point, it is usually necessary to fit automatically to non-standard line shapes (e.g. the platelet feature), in a failsafe way, with reasonable computational time and excellent reliability.

Fifth, it is often necessary to detect automatically very faint features which may be superimposed upon very strong baselines. This highly challenging issue may rely on baselining to a very high degree of accuracy, or alternatively using other novel methods which detect the feature without the variance that a baselining step entails. An example of this is the 1344 cm⁻¹ feature corresponding to the neutral single nitrogen defect in diamond, the presence of which is indicative of a synthetic diamond or a diamond that has been treated at high temperatures (>1900° C.). The automated method must be able to detect neutral nitrogen concentrations of 1 part per million (ppm) and above (corresponding to an absorption coefficient of only ˜0.02 cm⁻¹), potentially in the presence of a strongly varying background.

The acquisition of infra-red absorption spectra of diamonds is a well known technique and details are not reproduced here. Any suitable IR absorption or FTIR spectrometer can be used. Spectra are stored using any suitable medium and the data contained therein can be analysed using a processor.

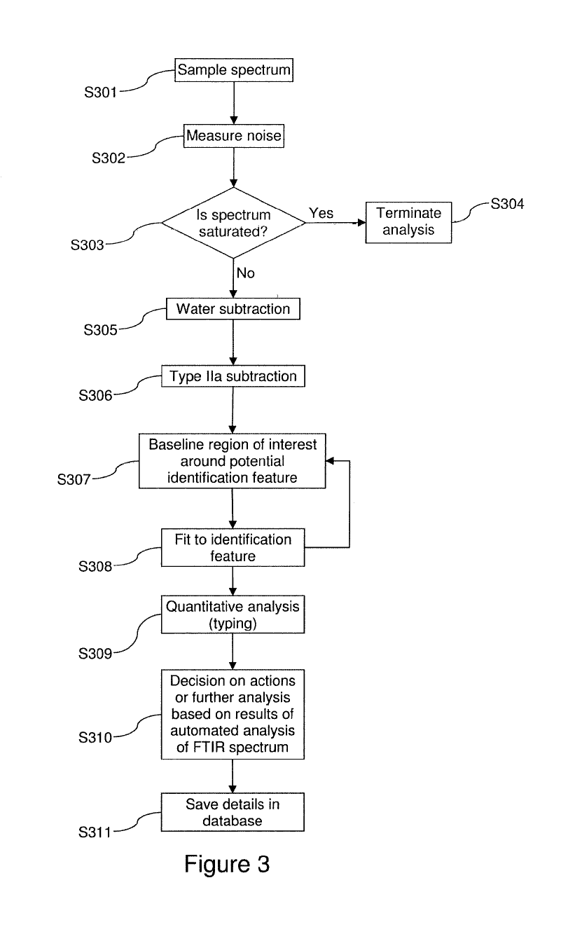

FIG. 3 is a flow chart illustrating high level steps involved in analysing the IR absorption spectrum of a diamond:
S301. An IR absorption spectrum is sampled to provide equidistant data points—i.e. the raw data are interpolated so that e.g. integer wavenumber positions are obtained at a single integer wavenumber resolution.
S302. The noise in the spectrum is measured.
S303. If the noise in the spectrum indicates that the spectrum is saturated, the stone is flagged up as such (S304) because it will not be possible to extract meaningful data automatically.
S305. If the spectrum is not saturated then further analysis is carried out. A reference spectrum of IR absorption by water is fitted to the spectrum over the spectral region of 3500-4000 cm⁻¹ using a linear non-negative least-squares fitting routine. The fitted reference spectrum is then subtracted from the sampled absorption spectrum.
S306. A reference spectrum of a high quality type IIa diamond is fitted to the region of the spectrum between 3500 cm⁻¹ and 4000 cm⁻¹ using a linear non-negative least-squares fitting routine. Alternatively, the absorption at 1992 cm⁻¹ is proportional to the thickness of the sample and can be used to normalise the spectrum. The fitted reference spectrum is subtracted from the normalised IR spectrum.
S307. A series of attempts are made to identify individual features in the spectrum. For each potential feature, a baseline is determined around the feature and the portion of the spectrum containing that feature (region of interest) mapped to the new baseline.
S308. For each feature, once the baseline has been identified and the feature mapped, a reference spectrum is fitted to the feature over the region of interest using a mixed Gaussian-Lorentzian nonlinear least-squares fitting routine. The intensity of each feature can thus be deduced from the factor required to fit each reference spectrum.
S309. Quantitative analysis (typing) is carried out by summing components from A, B, N_{S}⁰, N_{S}⁺ and D features, again using a linear non-negative least-squares fitting routine. A stone is allocated into a particular type depending on the relative concentrations of these features.
S310. Each stone is categorised depending on the type allocated in the previous step, together with additional features such as hydrogen and platelets. Thresholds for concentrations/relative concentrations may be used in determining the type of the stone.
S311. The outcome (i.e. fitted) data and the raw spectral data are saved to a database for future reference.

More details as to how the tests are carried out are provided below. The quantitative analysis in steps S307-S309 may involve a number of different tests to determine if a stone displays features characteristic of synthetic and/or treated diamond. In many cases these tests determine if the intensity of a particular feature is above a threshold value. Examples include, but are not limited to:
Detection of a line at 1450 cm⁻¹. If this is above a predetermined threshold the diamond is categorised as being likely to have been irradiated.
Detection of a line at 3123 cm⁻¹. If this is above a predetermined threshold the diamond is categorised as being likely to be CVD synthetic.
Three-component linear least-squares fit to the one-phonon region using A centre, B centre and D absorption features (3D fit).
Repeat the fit to the one-phonon region using A, B, D, Nₛ⁰ and Nₛ⁺ features (5D fit). χ² values from each fit are used to make a decision.
A check is made for the presence of a feature at 1344 cm⁻¹.

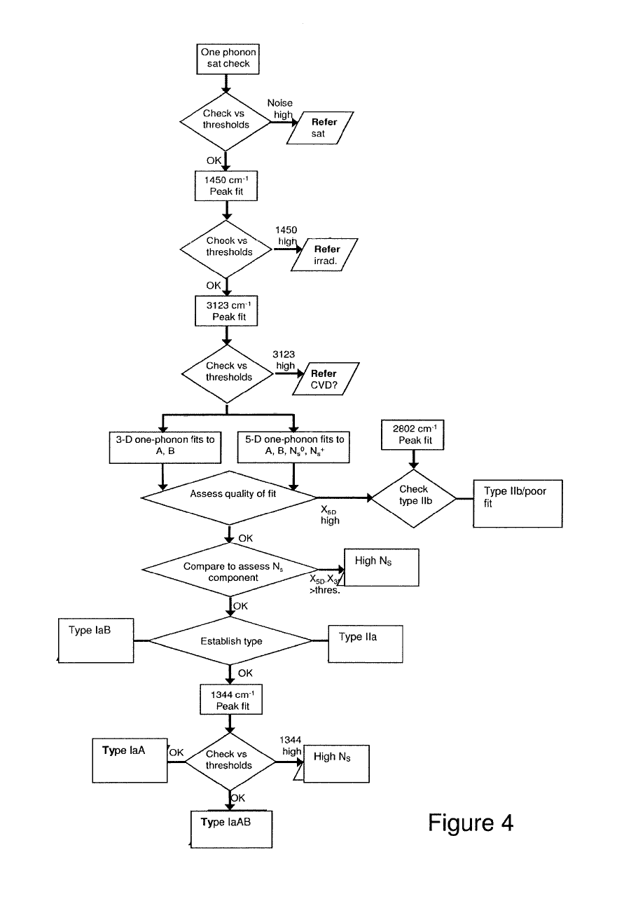

An example of how these tests may be implemented in practice is provided in FIG. 4.

Saturation Checking

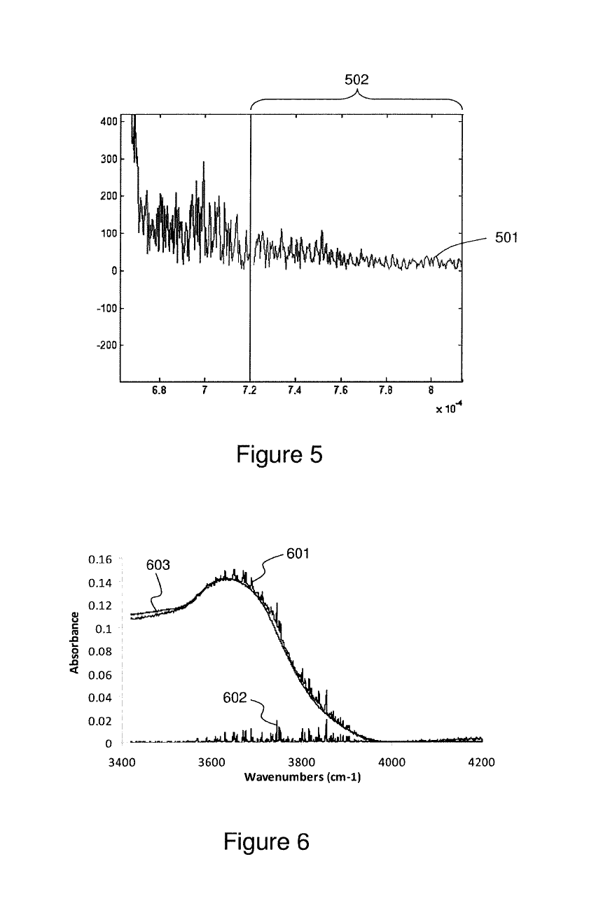

The saturation test at step S303 is carried out because saturation usually results in ‘high frequency’ noise which can be detected by Fourier transform of the signal and integration over a certain region in order to quantify the noise. FIG. 5 is a plot of fast-Fourier-transformed data 501 of an IR spectrum exhibiting significant saturation in the one-phonon region. Noise (but not signal) is detectable in the range 7.2-8.1×10⁻⁴ cm 502 (corresponding to 1200-1400 cm⁻¹). Integration within this range therefore allows the magnitude of high-frequency noise to be deduced. If the value obtained is above a certain threshold then the spectrum is rejected as ‘saturated’.

Baselining

The baselining in step S307 is important in order to be able to fit successfully to spectral features. The following strategies may be employed:
A number of ‘lowest points’ are found in specified regions of the spectrum and a second-order polynomial is fitted to these points and subtracted from the spectrum. Suitable ranges for fitting include 400-450 cm⁻¹, 1400-1650 cm⁻¹, 4500-4700 cm⁻¹ and 6800-6900 cm⁻¹. The process used is to perform one second order polynomial fit over the whole of the spectrum, using the datapoints in all of these ranges listed above as the input data to be fitted to. As shown in FIG. 3, baselines for individual features are also calculated. A feature for which a search will be made (e.g. the absorption line at 3123 cm⁻¹) is selected. Points are chosen at predefined increments away from the peak position of the selected feature (e.g. 3123−1 cm⁻¹, 3123+1 cm⁻¹, 3123+2 cm⁻¹) and a second-order polynomial function is fitted to these points and used as the baseline for this feature only.
Before fitting the feature at 1344 cm⁻¹ (N_{S}⁰), the linear least-squares one-phonon fit is subtracted from the spectral data, in order to obtain a cleaner background signal which may then be fitted using the methods described above.

Linear Least-Squares Fitting

Linear least-squares fitting is most appropriate for multi-component fits, where the shape of the spectral feature is not likely to change, e.g. not for Gaussian-broadened features. Therefore, linear least-squares fitting is suitable for subtracting water and type IIa spectra in steps S305 and S306, and for typing in the one-phonon region (S309). For these fits, a non-negative routine should be employed: a standard least-squares routine would yield negative fit values which would not have any sensible physical meaning.

Normalisation and Water Subtraction

The spectral region of 3500-4000 cm⁻¹ is used for fitting to a reference spectrum of a “perfect” type IIa diamond (for normalisation and removal of the diamond intrinsic absorption) and also the removal of water peaks (there are several strong water peaks in this region).

Likewise, a standard water spectrum is used as a reference over the spectral region of 3500-4000 cm⁻¹ to obtain a fit. To take account of possible movement of water peaks with respect to the data spectrum, the water reference spectrum is shifted in position incrementally by a small amount (e.g. 0.25 cm⁻¹) over a predetermined range (e.g. +/−1 cm⁻¹) and each shifted spectrum fitted to the data spectrum. The lowest χ² value which corresponds to the best fit may then be used for subtraction. FIG. 6 is a schematic illustration of an example of this being carried out in practice. As shown in FIG. 6, a sample spectrum 601 is fitted to a typical water spectrum 602 and type IIa spectrum 603, and both fitted spectra 602, 603 are then subtracted from the sample spectrum across the whole range (0-4000 cm⁻¹) to remove the features corresponding to intrinsic absorption by the diamond lattice and absorption by water.

As an alternative, the type IIa spectrum can be removed by measuring the IR absorption value at 1995 cm⁻¹, and calculating a normalisation constant as (11.95/measured absorption value). Each datapoint in the spectrum can be multiplied by this normalisation constant, following which the reference type IIa spectrum can be subtracted.

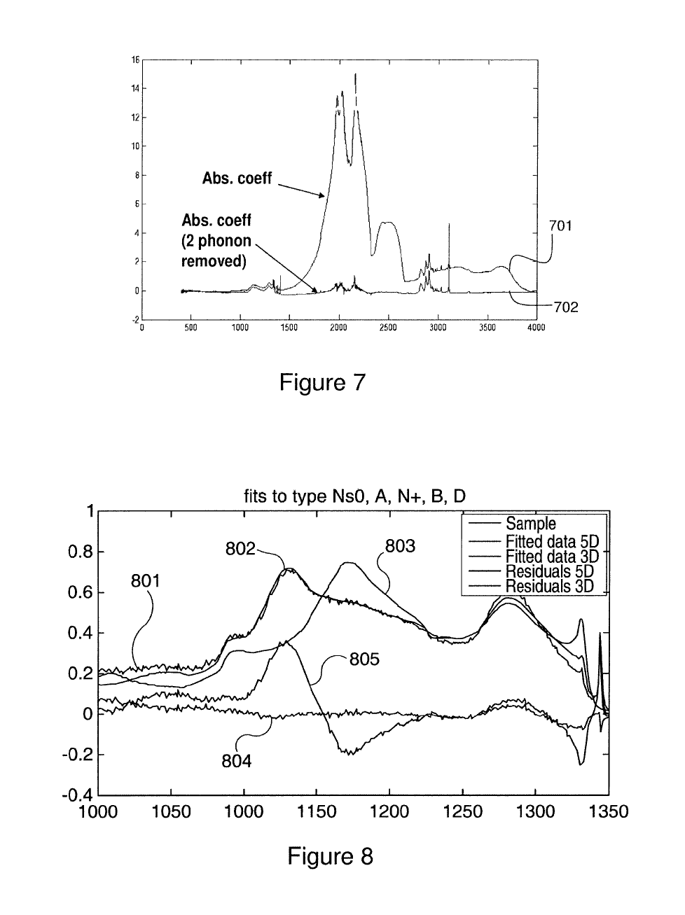

FIG. 7 illustrates an IR absorption spectrum before and after subtraction of fitted reference type IIa and water spectra. The initial spectrum 701 is dominated by the intrinsic diamond absorption, but the differenced spectrum 702 with the type IIa and water features subtracted makes baselining of the remaining features much more straightforward.

An alternative approach to water fitting is similar to the baselining approach for individual features described above. This approach only subtracts water features for the area around an individual feature when fitting to that feature. This approach deals well with spectrometer anomalies (e.g. that the water lines may not be the same shape as those in the reference spectrum, the lines in one region of the spectrum may not match those in another region, the lines may be shifted in position compared to the reference spectrum, and the degree of shift might be different in different regions of the spectrum). The water fitting in this approach is carried out as follows:
1. A region in the sample spectrum is chosen of approximately ±15 cm⁻¹ around an IR feature under investigation.
2. A water reference spectrum is obtained over the same spectral region by running the IR spectrometer without a sample present: atmospheric water will provide a suitable water signal.
3. The water reference spectrum Is shifted relative to the sample spectrum over increments of 0.25 cm⁻¹ to generate a series of shifted water spectra.
4. Each of the shifted water spectra is fitted over the small spectral range to the sample spectrum using a linear non-negative least squares fitting routine.
5. The fit that has the lowest χ² is chosen and subtracted from the sample spectrum over this region.

One-Phonon Fitting

The “typing” procedure in step S309 is achieved by fitting spectra for A, B, D, Nₛ⁰ and Nₛ⁺ features, at varying relative rates of intensity, to the spectrum under investigation. Reference spectra, each containing features corresponding to the A, B, X, Nₛ⁰ and Nₛ⁺ centres respectively between 1000 and 1399 cm⁻¹ are stored in a text file. As with the type IIa and water spectra, these reference spectra have data points separated by the same amount as the sampled data points in the spectrum under investigation (e.g. 1 cm⁻¹).

Initially a three-component fit to the one-phonon region is made using only A, B and D absorption features (herein described as a 3D fit). The fit is then repeated using the A, B, D, Nₛ⁰ and Nₛ⁺ features (known as a 5D fit). The χ² values from each fit are used to make a decision. Essentially, if the 5D fit is better than the 3D fit then it can be concluded that absorption by single substitutional nitrogen is present in the one-phonon region and the stone must be referred.

This can be seen in FIG. 8, which illustrates an absorption spectrum (“sample”) 801 over a spectral range of 1000-1350 cm⁻¹. This spectrum has been fitted using all five features in a 5D fit 802 and using only A, B, and D-components in a 3D fit 803. It can be seen that the 5D fit is significantly better than the 3D fit: the residual 804 between the 5D fit and sample is nearly flat at zero, whereas the residual 805 for the 3D fit contains significant deviations.

In more detail, the decision-making process may be as follows using predetermined threshold values (identified by comparison with values in known samples):
To exclude spectra with a poor one-phonon fit:
   If χ²_{3D}>threshold or χ²_{5D}>threshold then give a ‘poor fit’ result
to see if Nₛ is part of spectrum:

D=χ²_{3D}−χ²_{5D}
If D negative, pass −3D fit is better than 5D fit, i.e. Nₛ not detected in one-phonon region.
If D positive, check:
   If D/χ²_{5D}>threshold, then Nₛ is part of spectrum→exclude

Typing may be performed as follows (in combination with [B⁰] deduced from the strength of the 2802 cm⁻¹ feature discussed below):
If [A]+[B]>type I/II_{threshold} then type is ‘I’
   if [A]<A_{threshold} then type is ‘IaB’
   likewise if [B]<B_{threshold} then type is ‘IaA’
If [A]+[B]<type I/II_{threshold} then type is ‘II’
   If [B⁰]>IIb_{threshold} then type=‘IIb’
   Otherwise type is ‘IIa’

Nonlinear Least-Squares Fitting

Nonlinear fitting is generally applicable for peaks where the width, position and/or shape can vary, or where the feature can be approximated sensibly with a mathematical expression (e.g. a Gaussian). Nonlinear fitting is performed on at least the following IR peaks:
1450 cm⁻¹ (irradiation-related)
3123 cm⁻¹ (CVD-related)
1344 cm⁻¹ (Nₛ⁰)
2802 cm⁻¹ (corresponding to substitutional boron (B⁰))

FIG. 9 illustrates an example of non-linear fitting of a platelet B′ feature 902 to a sample spectrum 901. It will be noted from FIG. 2 that the peak is broad and has a long tail. This leads to a number of challenges in fitting it, but a suitable approach can proceed as follows:
1) The region where the platelet will exist is chosen, e.g. between 1350 (xstart) and 1400 cm⁻¹ (xend)
2) An initial 2^{nd} order polynomial fit is performed over this region and subtracted from the sample spectrum. All regions <0 are set to zero. This roughly removes the background.
3) A set of ‘theoretical Gaussians’ is generated to fit against this. For the platelet region selected in this example, i.e. 1350-1400 cm⁻¹, there may be 51 Gaussians generated, at peak positions of 1350, 1351, 1352 . . . cm⁻¹ up to 1400 cm⁻¹. Real data on untreated natural diamonds can be used to deduce approximations of what the widths are likely to be for each Gaussian, although it should be noted that the width varies as a function of position.
4) All of these are fitted Gaussians to the roughly background-subtracted spectral data (from step 2 above) using a non-negative least-squares routine. The Gaussian that has the lowest chi-squared is chosen as the one with the best fit. Hence, an approximation of the platelet position, width and height have been found (from the parameters that correspond to this Gaussian fit).
5) From the original sample data (from step 1), between xstart and xend, select two regions:
   (xstart) to (the peak position−2× the peakwidth); and
   (the peak position+3× the peakwidth) to xend.
These two regions together effectively select the region of the sample data from xstart to xend that do not include the platelet peak including its long tail.
6) A 2^{nd} order polynomial fitting is performed on this region and subtracted from the sample data between xstart and xend. This has therefore effectively removed the background and provided a baseline for the platelet peak.
7) The initial guesses of peak position, width and height (from step 4 above) are used as the initial guess values for the fitting of the properly background-subtracted platelet peak.
8) A fit to the background-subtracted platelet peak is carried out using an asymmetric double sigmoidal function:

$$y = \frac{1}{2} [ tan h ( \frac{x - {c}_{1}}{{w}_{1}} ) - tan h ( \frac{x - {c}_{2}}{{w}_{2}} ) ] with constraints {w}_{1} > 0 and {w}_{2} > 0.$$

9) A nonlinear least-squares fitting method is used to minimise the value of chi-squared.
10) From the fit are deduced the peak position (maximum value), the width (FWHM from the half-height values), asymmetry (ratio of the left half-height to the right half-height) and area (trapezoidal integration).
11) Known threshold values for position/width, width/asymmetry etc. can then be applied in order to determine if the stone is treated or not.

In practice, steps 7-10 can be swapped for a simple position, width and FWHM measurement of the background-subtracted spectrum (a procedure similar to step 9 but on the actual data rather than the fit), which works almost as well.

In order to obtain an accurate fit, it is useful to provide an initial indication for the width of the feature. The 2802 cm⁻¹ feature, when present, would be significantly wider than the other features and the initial conditions needed to take account of this. It is also important to set sensible boundary conditions for fitting.

It is also possible to resolve very small features at 1344 cm⁻¹ even when there is a significant background signal, by using a smoothed inverted double differential of the spectrum followed by FWHM measurement. This has many advantages compared to standard peak fitting, in particular that it is not necessary to fit the background, which is difficult if the peak is small and the background is large. This can be achieved as follows:
1. The required spectral region (1335-1350 cm⁻¹) is chosen.
2. The data is interpolated to get enough data points e.g. a wavenumber step size of 0.1
3. The data is differentiated.
4. The data is smoothed (e.g. using a simply moving average smoother with a dataspan of 8).
5. The region of 1342-1346 cm⁻¹ is differentiated.
6. Any values <0 are truncated to zero.
7. The spectrum is inverted.
8. The same smoothing filter used previously is applied again.
9. The maximum y value of the spectrum and the corresponding x-value (peak position) are located.
10. The spectrum is integrated using a trapezoidal integration method.
11. The peak position and the result of the trapezoidal integration are used to deduce whether the peak is present or absent, by applying thresholds.

From the fit data parameters, it is desirable to remove erroneous fits by setting thresholds on peak position and width. It is also desirable to set an amplitude threshold above which a ‘peak detected’ result can be output. These thresholds can be set by fitting to various IR spectra of irradiated, CVD synthetic, Nₛ⁰-containing and type IIb diamonds.

Database

In step S311 details of the fitted data and the raw spectral data are saved to a database, together with the parameters of all the features and fits determined during analysis, together with the outcome of the analysis. This enables individual stones to be tracked, and the data can also be used to improve further fitting algorithms or to inform additional analysis on a diamond.

FIG. 10 is a schematic illustration of a system 1001 suitable for putting the methods described into practice. The system 1001 includes a storage medium 1002 onto which spectra collected by an FTIR spectrometer, for example, are saved in the form of data files 1003. The storage medium may include memory such as RAM, ROM, EEPROM, flash memory, a hard disk, or combinations of the above. A processor 1004 is configured to operate software 1005 stored in the storage medium to analyse the data files 1003 using the methods described above, to identify whether the spectra indicate that the stones from which the spectra have been obtained are likely to be untreated, treated or synthetic diamond. The results of the analysis may be saved in a database 1006 which may be held in the storage medium 1002 or elsewhere.

1. A method of automating the classification of a diamond gemstone, comprising:
subtracting, from an infra-red absorption sample spectrum of the gemstone, features corresponding to absorption by water vapour and features corresponding to intrinsic absorption by a diamond lattice;
analysing the sample spectrum to identify predetermined absorption features corresponding to lattice defects in the diamond;
classifying the gemstone according to the presence and/or intensities of the predetermined absorption features; and
saving the results of the classification in a database.

2. The method of claim 1, further comprising:
calculating a baseline for the sample spectrum by identifying a plurality of local minima in specified regions of the spectrum and fitting a second-order polynomial to the local minima and
subtracting the baseline from the formatted spectrum.

3. The method of claim 2, wherein the specified regions include one or more of:
a region from the lowest wavenumber point recorded in the formatted spectrum to a point up to 50 cm⁻¹ higher;
1400-1650 cm⁻¹;
4500-4700 cm⁻¹; and
a region from 200-100 cm⁻¹ less than the highest wavenumber point recorded in the spectrum.

4. The method of claim 1, further comprising:
fitting to the sample spectrum, within a region corresponding to one-phonon absorption, a combination of some or all of the following reference spectra:
a reference A spectrum including features characteristic of IR absorption by A centres;
a reference B spectrum including features characteristic of IR absorption by B centres;
a reference D spectrum including features characteristic of IR absorption by X centres;
a reference N_{S}⁰ spectrum including features characteristic of IR absorption by N_{S}⁰ centres; and
a reference N_{S}⁺ spectrum including features characteristic of IR absorption by N_{S}⁺ centres;
determining intensities of some or all of the A, B, D, N_{S}⁰ and N_{S}⁺ centres on the basis of the fitting to the reference spectra; and
classifying the stone on the basis of the determined intensities.

5. The method of claim 4, further comprising:
performing a three-component fit to the sample spectrum within the region corresponding to one-phonon absorption using the reference A, B and D spectra;
performing a five-component fit to the sample spectrum within the region corresponding to one-phonon absorption using the reference A, B, D, N_{S}⁰ and N_{S}⁺ spectra;
comparing the quality of the three-component and five-component fits, optionally using a χ² test; and
classifying the diamond on the basis of the quality comparison.

6. The method of claim 5, further comprising determining that, if the five-component fit is better than the three-component fit by more than a predetermined threshold, a significant proportion of single substitutional nitrogen is present in the stone.

7. The method of claim 4, wherein the fitting is carried out using linear non-negative least squares fitting.

8. The method of claim 1, further comprising:
calculating local baselines for absorption features, the local baseline for each feature being calculated by fitting a second-order polynomial to a plurality of data points in the sample spectrum at predefined wavenumber increments either side of a peak position of that feature; and
subtracting each local baseline from a region surrounding the corresponding absorption feature; and
fitting a suitable function to each absorption feature to identify the intensity of that feature.

9. The method of claim 8, wherein fitting a suitable function to a given absorption feature includes non-linear least-squares fitting.

10. The method of claim 9, wherein the non-linear least squares fitting is applied to absorption lines at 1450 cm⁻¹, 3123 cm⁻¹, 1344 cm⁻¹ and/or 2802 cm⁻¹, and/or to absorption features corresponding to platelets.

11. The method of claim 9, wherein the non-linear least squares fitting to a given absorption feature comprises choosing a region of the sample spectrum between a start wavenumber and a finish wavenumber in which the absorption feature to be fitted is expected to reside.

12. The method of claim 11, further comprising performing a 2nd order polynomial fit over the chosen region, subtracting the polynomial fit from the sample spectrum, and setting to zero all regions below zero in the chosen region of sample spectrum following the subtraction.

13. The method of claim 11, further comprising:
fitting a set of theoretical Gaussians to the chosen region using non-negative least squares fitting;
choosing the Gaussian with the lowest χ²;
identifying the width, position and height of the chosen Gaussian;
fitting a 2nd order polynomial to an area in the chosen region not including the chosen Gaussian; and
subtracting the fitted polynomial from the sample spectrum in the chosen region.

14. The method of claim 13, wherein the area not including the chosen Gaussian is determined as extending from the start wavenumber to the peak position of the chosen Gaussian minus a first predetermined multiple of the width, and from the peak position plus a second predetermined multiple of the width to the end wavenumber.

15. The method of claim 11, further comprising fitting an asymmetric double sigmoidal function to the chosen region of the sample spectrum using a nonlinear least-squares fitting method to minimise χ², and deducing the peak position, width, asymmetry and area of the fitted function.

16. The method of claim 11, wherein the chosen region extends from 1350-1400 cm⁻¹ and the given absorption feature corresponds to absorption by platelets.

17. The method of claim 1, further comprising:
differentiating and smoothing the data over a chosen region in which a particular absorption feature is expected to reside;
differentiating and smoothing the data over a subset of the chosen region in which the absorption feature is expected to reside;
truncating any values below zero to zero;
inverting and smoothing the spectrum;
identifying the location of the highest peak position;
integrating the spectrum using a trapezoidal integration method; and
deducing from the peak position and the result of the integration, using thresholds, whether the particular absorption feature is present or absent.

18. The method of claim 17, wherein the chosen region is 1335-1350 cm⁻¹, the subset is 1342-1346 cm⁻¹ and the particular absorption feature is at 1344 cm⁻¹.

19. The method of claim 1, wherein:
subtracting features corresponding to absorption by water includes fitting the spectrum over a predetermined spectral range to a reference water spectrum including features characteristic of absorption by water, and subtracting the fitted water spectrum from the sample spectrum; and/or
subtracting features corresponding to intrinsic absorption by the diamond lattice includes fitting the spectrum over a predetermined spectral range to a reference type IIa spectrum including features characteristic of absorption by a type IIa diamond, and subtracting the fitted type IIa spectrum from the sample spectrum;
and wherein the fitting to the water and/or type IIa spectrum is optionally carried out using a linear non-negative least squares fit.

20. The method of claim 19, wherein fitting the absorption spectrum to a reference spectrum of absorption by water comprises:
shifting the reference water spectrum incrementally to a plurality of different wavenumber positions over a predetermined range and fitting the water spectrum to the absorption spectrum at each position; and
comparing the fit at each wavenumber position;
and wherein the method further comprises subtracting the shifted spectrum having the best fit.

21. The method of claim 20, wherein fitting the absorption spectrum to a reference spectrum of water is carried out across a small region either side of an absorption feature under investigation, and the shifted reference spectrum having the best fit is subtracted only from the small region before fitting to the absorption feature.

22. The method of claim 1, wherein subtracting features corresponding to intrinsic absorption by the diamond lattice includes determining the absorption value at 1995 cm⁻¹, calculating a normalisation constant as 11.95 divided by the absorption value, multiplying the spectrum by the normalisation constant, and subtracting a reference type IIa spectrum from the sample spectrum following normalisation.

23. The method of claim 1, further comprising testing the absorption spectrum for saturation by measuring the noise over a predetermined spectral region in which no absorption features are present and excluding the stone if the noise exceeds a predetermined threshold.

24. The method of claim 23, wherein measuring the noise comprises integrating a Fourier transform of the spectrum over the predetermined spectral region, optionally approximately 1200-1400 cm⁻¹.

25. The method of claim 1, further comprising recording the sample infra-red absorption spectrum of the gemstone.

26. Apparatus configured to carry out the method of claim 1.

27. A computer program comprising computer readable code which, when operated by a processor, causes the processor to carry out the method of claim 1.

28. A computer program product comprising a computer readable medium and a computer program according to claim 27, wherein the computer program is stored on the computer readable medium.
